(19) United States
(12) Patent Application Publication
(10) Pub. No.: US 2012/0318544 A1
(43) Pub. Date: Dec. 20, 2012

(54) ROTATION SPEED CONTROL DEVICE FOR AIR TOOLS AND ROTATION SPEED CONTROL METHOD THEREOF

(75) Inventors: YUNG-YUNG SUN, Taichung City (TW); CHUAN-CHING CHENG, Taichung City (TW)

(73) Assignee: STORM PNEUMATIC TOOL CO., LTD., TAICHUNG CITY (TW)

(21) Appl. No.: 13/162,751

(22) Filed: Jun. 17, 2011

(51) Int. Cl. B25F 5/00

(52) U.S. Cl. 173/1; 173/221

(57) ABSTRACT

A rotation speed control device for air tools and the method thereof are disclosed. A shell base is disposed with a forward air inlet and a reverse air inlet. A back cover is connected to one side of the shell base. The back cover has a forward flow path in communications with the forward air inlet and a reverse flow path in communications with the reverse air inlet. The forward flow path has a rotation space whose one side has a pressure release hole in communications with the ambient space. A rotation speed control element having a stopping part that can close the pressure release hole is disposed in the rotation speed. The rotation speed control element rotates to control the aperture size of the pressure release hole, thereby adjusting the airflow entering the forward flow path.

### BACKGROUND OF THE INVENTION

1. Field of Invention

The invention relates to an air tool and, in particular, to a rotation speed control device for the air tool and the rotation speed control method thereof.

2. Related Art

The rotation speed control device for a conventional air tool is shown in FIG. 7. It includes a rotational cylinder 71 and a knob 72. The rotational cylinder 71 has several through holes 73. The forward air inlet 74 of the redirection mechanism of the air tool can align with any of the through holes 73 on the rotational cylinder 71. The reverse air inlet 75 misaligns with the rotational cylinder 71. When the air tool rotates forward, the air entering the through holes 73 of different sizes on the rotational cylinder 71 results in different rotation speeds (i.e., different torques). When the air tool rotates in reverse, the entering air is directly guided into the reverse inlet 75 of the rotational cylinder 71. The rotation speed in this case is not restricted by any of the through holes 73 on the rotational cylinder 71 and is maximal. Therefore, no matter what the torque of forward rotation is, the rotation speed is always maximal when it is switched to the reverse mode. The torque for loosening a screw can thus increase. Nevertheless, the prior art has the following problems.

Since the speed adjusting device and the redirection mechanism 76 are coaxially integrated on the switch bar 77 on the handle, there is thus the problem that some part of the air tool is too crowded with many elements, thus difficult to assemble.

Moreover, the speed adjusting device and the redirection mechanism 76 are coaxially integrated on the switch bar 77 on the handle and there is an exhaust path W between the redirection mechanism 76 and the valve sleeve 78. The sizes of the redirection mechanism 76 and the valve sleeve 78 have to match with the switch bar 77 and the speed adjusting device. The cross section of the exhaust path W is thus restricted by the redirection mechanism 76 and the valve sleeve 78, reducing the output torque.

### SUMMARY OF THE INVENTION

An objective of the invention is to provide a rotation speed control method for an air tool and the rotation speed control method thereof. When the air tool is in the forward mode, the rotation speed (torque) is adjustable. When the air tool is in the reverse mode, the rotation speed (torque) is kept maximal.

Another objective of the invention is to implement easy assembly while preventing insufficient airflow due to small cross sections of air intake and exhaust paths.

To achieve the above-mentioned objectives, the disclosed rotation speed control device for an air tool includes:

a shell base in the body of an air tool, the shell base having a forward air inlet and a reverse air inlet;

a back cover connected to one side of the shell base, having a forward flow path in communications with the forward air inlet and a reverse flow path in communications with the reverse air inlet, wherein the forward flow path has a rotation speed whose one side has a pressure release hole connected to the outside of the back cover;

a rotation speed control element, whose one section is in the rotation speed and whose other section exposes from the air tool body.

The section of the rotation speed control element exposed from the air tool body is provided with a knob. Turning the knob rotates the rotation speed control element in the rotation space. The section of the rotation speed control element in the rotation space has a stopping part and a balancing part. The two opposite inner walls facing the forward flow path in the rotation space are concave. The outer edge surfaces of the stopping part and the balancing part of the rotation speed control element are curved to match the inner walls of the rotation space. The rotation speed control element rotates a predetermined angle in the rotation space so that the stopping part blocks the entire or part of the pressure release hole, thereby controlling the aperture size thereof. The airflow from the forward air inlet to the forward flow path is thus adjusted.

This specification also discloses a rotation speed control method for an air tool. A forward flow path on a back cover of an air tool releases high-pressure air via a pressure release hole. A rotation speed control element that can turn a predetermined angle in the forward flow path is used to control the aperture size of the pressure release hole for the high-pressure air, thereby adjusting the air flux and thus the rotation speed. When the high-pressure air enters a reverse flow path of the air tool, the rotation speed for the reverse mode is not affected by the choice of the forward mode.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a three-dimensional exploded view of the invention;

FIG. 2 is a local three-dimensional exploded view of the invention;

FIG. 3 is a planar cross-sectional view of the invention;

FIG. 4 is a schematic view of the invention in use, where the air tool rotates forward at the highest speed thereof;

FIG. 5 is a schematic view of the invention in use, where the rotation speed of the air tool is adjustable in the forward mode;

FIG. 6 is another schematic view of the invention in use, where the air tool is in the reverse mode; and

FIG. 7 is a structural view of the speed adjusting device of a conventional air tool.

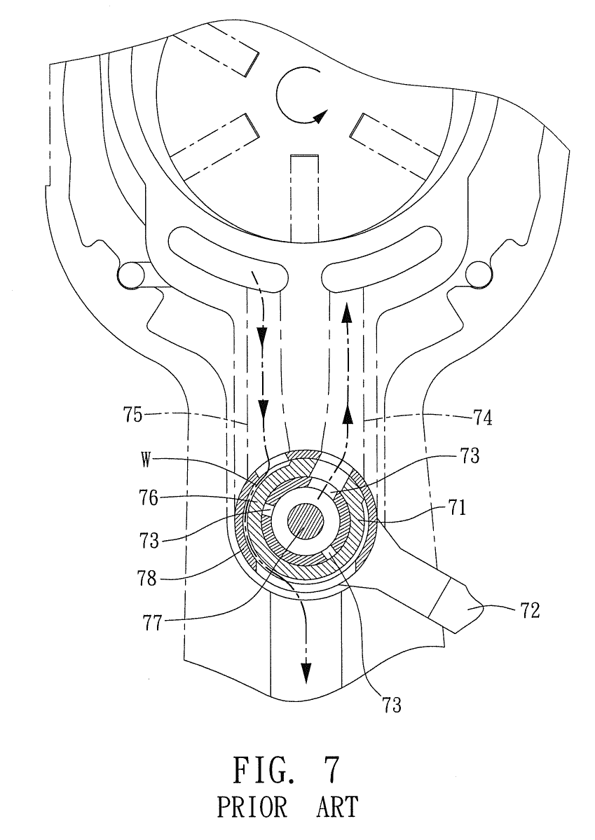

### DETAILED DESCRIPTION OF THE INVENTION

The present invention will be apparent from the following detailed description, which proceeds with reference to the accompanying drawings, wherein the same references relate to the same elements.

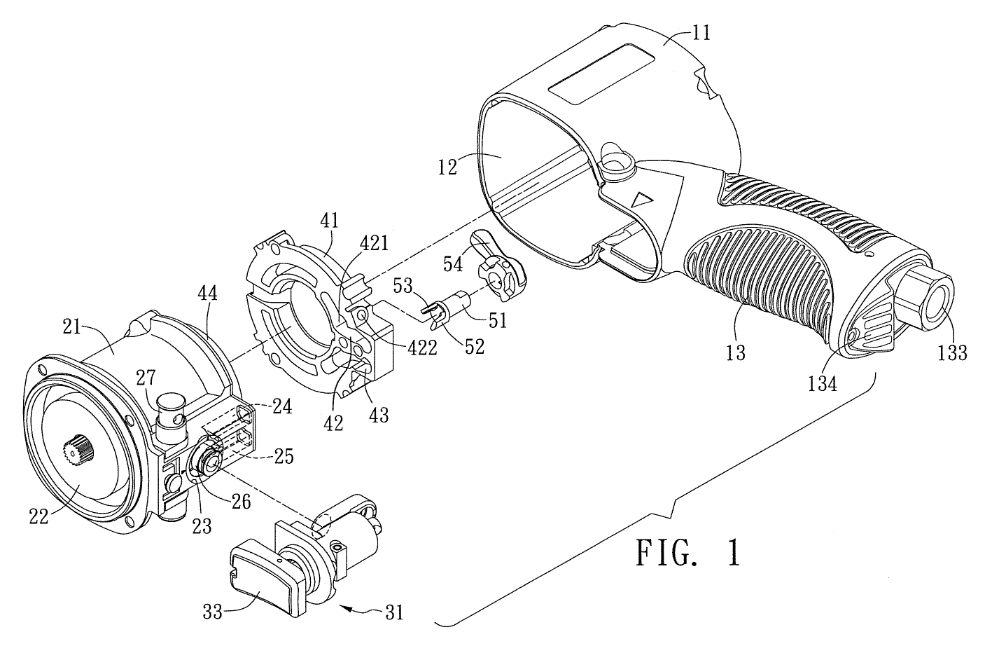

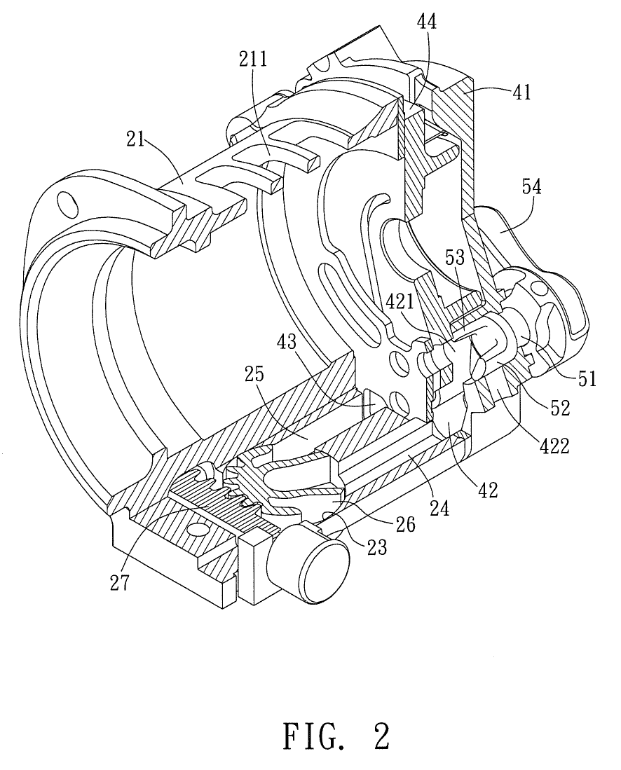

Please refer to FIGS. 1 to 3. The disclosed rotation speed control device for an air tool consists of a body 11 with a shell base 21, a back cover 41, and a rotation speed control element 51 inside.

The body 11 has an accommodating space 12. The lower part of the body 11 is extended with a handle 13 having an intake passage 131 and an exhaust passage 132. The intake passage 131 has a connecting part 133 exposed at the bottom of the handle 13 for the connection of a high-pressure air pipe. The exhaust passage 132 has several exhaust outlets 134.

The shell base 21 is hollow and disposed in the accommodating space 12 of the body 11. The shell base 21 has a motor component 22. The bottom of the shell base 21 further has a recess 23. One side of the inner wall of the recess 23 is formed with a forward air inlet 24 and a reverse air inlet 25 in communications with the outside of the shell base 21. The top of the shell base 21 is formed with several through holes 211.

A switch set 31 is disposed at the top of the handle 13 and under the shell base 21. The switch set 31 has a control part 32 for closing the intake passage 131 and a trigger 33. The recess 23 has a redirection mechanism 26 having a redirection control element 27 to control the high-pressure air in the intake passage 131 to enter the forward air inlet 24 or the reverse air inlet 25.

The back cover 41 aligns with the opening on one side of the shell base 21. In this embodiment, there is a pad 44 between the back cover 41 and the shell base 21. The end surface opposite to the shell base 21 on the back cover 41 is formed with a forward flow path 42 in communications with the forward air inlet 24 of the shell base 21 and a reverse flow path 43 in communications with the reverse air inlet 25 of the shell base 21. When the high-pressure air enters the forward flow path via the forward air inlet 24, the motor component 22 is driven forward. On the other hand, when the high-pressure air enters the reverse flow path 43 via the reverse air inlet 24, the motor component 22 is driven reversely. There is a rotation space 421 in the forward flow path 42. The rotation space 421 is located in the forward flow path 42 near the front end of the forward air inlet 24. One side of the rotation space 421 is formed with a pressure release hole 422 connected to the outside of the back cover 41. The two opposite inner walls of the rotation space 421 at the forward flow path 42 are concave.

The rotation speed control element 51 extends from the outside of the air tool body 11 into the rotation space 421 of the back cover 41 and can rotate therein. The section of the rotation speed control element 51 in the rotation space 421 has a stopping part 52 and a balancing part 53. The outer edge surfaces of the stopping part 52 and the balancing part 53 of the rotation speed control element 51 match the two concave inner walls of the rotation space 421. The stopping part 52 closes part of or the entire pressure release hole 422 when the rotation speed control element 51 rotates a predetermined angle in the rotation space 421. The section of the rotation speed control element 51 exposed from the air tool body 11 has a knob 54 for its user to operate. Turning the knob 54 rotates the stopping part 52, thereby changing the relative position between the stopping part 52 and the pressure release hole 422. The aperture size of the pressure release hole 422 is thus adjusted to control the air flux entering the forward flow path 42 via the forward air inlet 24.

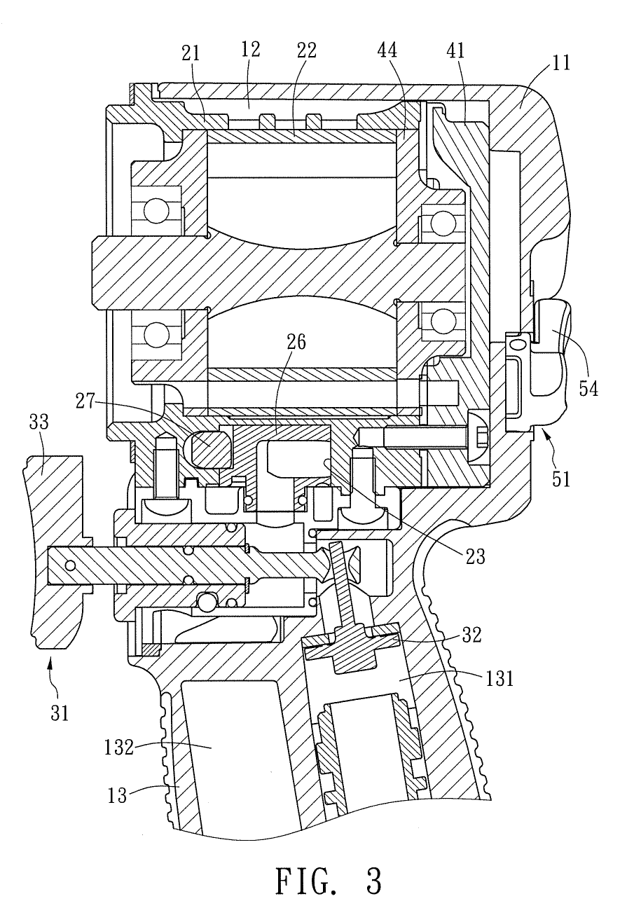

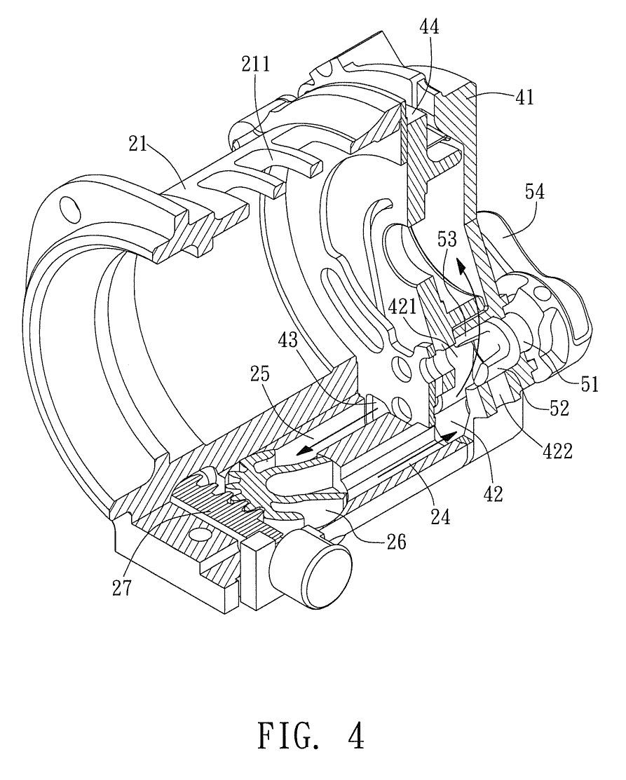

Please refer to FIGS. 3 and 4. When the high-pressure air entering the intake passage 131 is controlled by the redirection mechanism 26 to enter the forward flow path 42 of the back cover 41 via the forward air inlet 24 of the shell base 21, the motor component 22 in the shell base 21 is pushed by the high-pressure air to rotate forward. Since the stopping part 52 of the rotation speed control element closes the pressure release hole 422, the high-pressure air entering the forward flow path 42 is not released. The entire high-pressure air thus pushes the motor component 22 to rotate at maximum speed (torque). The high-pressure air after pushing the motor component 22 goes through in sequence the reverse flow path 43 of the back cover 41 and the through holes 211 of the shell base 21 to escape. Some air goes through the reverse air inlet 25 and the exhaust passage 132 to go out.

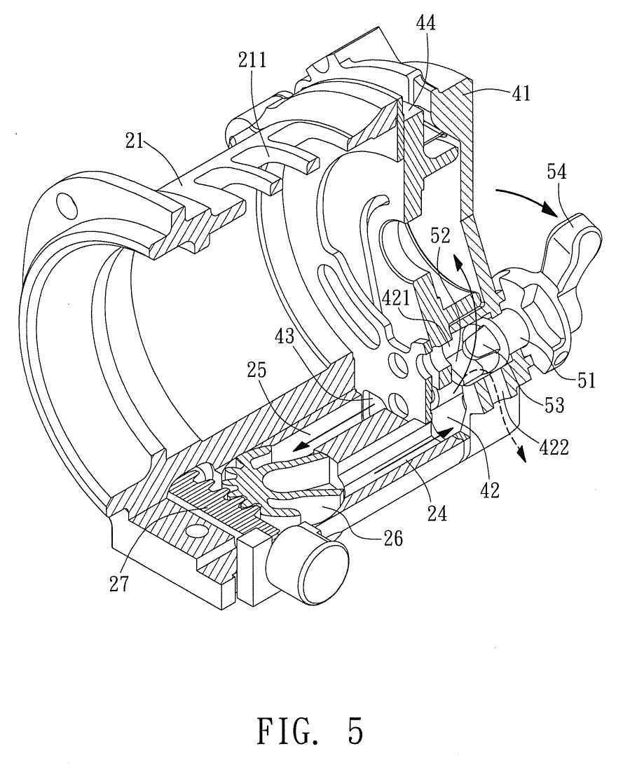

To adjust the forward rotation speed of the air tool, the user only need to turn the knob 54 of the rotation speed control element 51 so that the stopping part 52 does not completely close the pressure release hole 422. Please refer to FIGS. 3 and 5. The high-pressure air entering the forward flow path 42 via the forward air inlet 24 is as indicated by the dashed arrow in FIG. 5. Some of it is released via the pressure release hole 422. It leaves via the exhaust passage 132 of the handle 13. In this way, one can adjust the air flux entering the forward flow path 42 to push the motor component 22. As the stopping part 52 changes its angle, the relative position between the stopping part 52 and the pressure release hole 422 is changed to vary the aperture size of the pressure release hole 422. Therefore, the rotation speed is adjustable according to the air flux in the forward flow path 42.

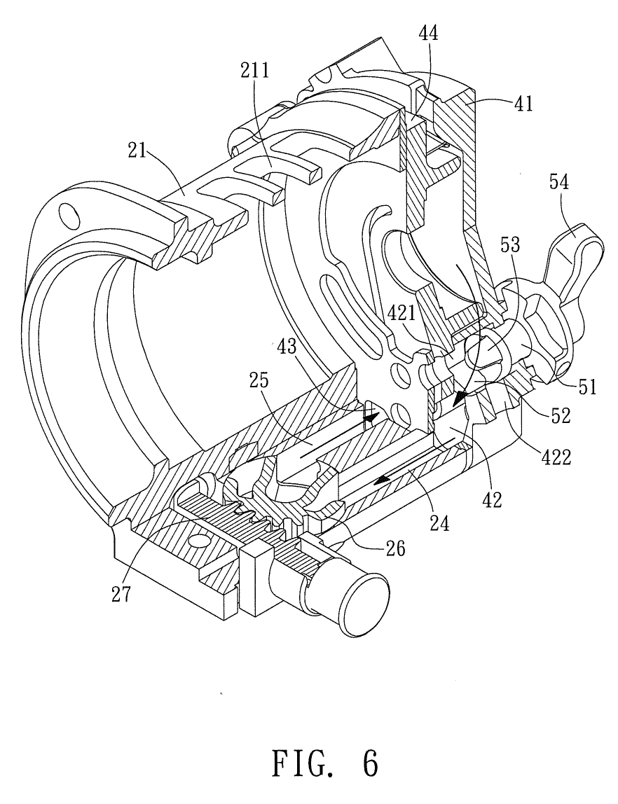

Please refer to FIGS. 3 and 6 for the air tool in the reverse mode. The high-pressure air entering the intake passage 131 is controlled by the redirection mechanism 26 to enter the reverse flow path 43 of the back cover 41 via the reverse air inlet 25 of the shell base 21. The motor component 22 is pushed by the high-pressure air to rotate reversely. The high-pressure air pushing the motor component 22 goes through in sequence the forward flow path 42 of the back cover 41 and the through holes 211 of the shell base 21 to escape. Some of it further goes through the forward air inlet 24 and the exhaust passage 132 before leaving the air tool. It should be noted that the pressure release hole 422 is formed in the forward flow path 42. No matter where the stopping part 52 of the rotation speed control element 51 is during forward rotation, the reverse rotation is run at the maximum air flux. Besides, the pressure release hole 422 functions as an auxiliary exhaust hole when the air tool is in the reverse mode, so that the entire high-pressure air is used to push the motor component 22 for maximum speed rotation. No matter what rotation speed the air tool is in the forward mode, the rotation speed is always maximal when it is switched to the reverse mode. Therefore, always the maximum torque is used to loosen a screw.

Since the rotation speed control device is separate from the redirection mechanism and the switch set 31 in the invention, instead of being mounted on the switch set 31 of the handle, the assembly becomes much simpler.

Moreover, the separation between the rotation speed control device and the redirection mechanism and the switch set 31 prevents the intake and exhaust passages from being blocked. The invention is thus more suitable for an air tool with a larger torque output.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. A rotation speed control device for an air tool, comprising:
a shell base disposed in the body of the air tool, the shell base having a forward air inlet and a reverse air inlet;
a back cover connected to one side of the shell base, having a forward flow path in communications with the forward air inlet and a reverse flow path in communications with the reverse air inlet, wherein the forward flow path has a rotation space whose one side has a pressure release hole connected to the outside of the back cover; and
a rotation speed control element whose one section is in the rotation space and whose other section exposes to the outside of the air tool body, the section of the rotation speed control element exposed from the air tool body having a knob so that the rotation speed control element is rotated in the rotation space by turning the knob;
wherein the section of the rotation speed control element in the rotation space has a stopping part and a balancing part; the two opposite inner walls of the rotation space corresponding to the forward flow path are concave; the outer edge surfaces of the stopping part and the balancing part of the rotation speed control element are curved to match the two concave inner walls of the rotation space; the rotation speed control element rotates a predetermined angle in the rotation space to close part of the or the entire pressure release hole to adjust the aperture size thereof, thereby adjusting the air flux entering the forward flow path via the forward air inlet.

2. The rotation speed control device for an air tool of claim 1, wherein the rotation space is located in the forward flow path near the front end of the forward air inlet.

3. A rotation speed control method for an air tool, comprising the steps of:
using a pressure release hole in a forward flow path of a back cover of the air tool to release part of high-pressure air;
using a rotation speed control element that is rotatable by a predetermined angle in the forward flow path to control the aperture size of the pressure release hole, thereby adjusting the air flux entering the forward flow path; and
when the high-pressure air enters a reverse flow path of the air tool, using the full air flux for reverse rotation such that the reverse rotation speed does not have any dependence on the adjusted high-pressure air flux used in the forward flow path for forward rotation.
